(19) United States
(12) Patent Application Publication
(10) Pub. No.: US 2024/0179766 A1
(43) Pub. Date: May 30, 2024

(54) EXTENDING NETWORK COORDINATION FOR SHORT-RANGE NETWORKS TO REMOTE DEVICES

(71) Applicant: PowerFlex Systems, LLC, San Diego, CA (US)

(72) Inventor: Chad HOLCOMB, Salt Lake City, UT (US)

(21) Appl. No.: 18/523,344

(22) Filed: Nov. 29, 2023

Related U.S. Application Data
(60) Provisional application No. 63/429,091, filed on Nov. 30, 2022.

(51) Int. Cl. H04W 76/10; G06F 13/42

(52) U.S. Cl. CPC H04W 76/10; G06F 13/4282; G06F 2213/0042; H04W 84/18

(57) ABSTRACT

Certain aspects of the present disclosure provide a method for extending a personal area network, including: instantiating a plurality of network coordinators; instantiating a plurality of short-range networks (SRNs), each SRN of the plurality of SRNs being associated with a unique network coordinator of the plurality network coordinators; associating a remote device with a first SRN of the plurality of SRNs; transmitting data to the remote device via a communication adapter and the first SRN; and receiving data from the remote device via the communication adapter and the first SRN.

### CROSS REFERENCE

This application claims the benefit of U.S. Provisional Application Ser. No. 63/429,091, filed Nov. 30, 2022, which is hereby incorporated by reference in its entirety.

### INTRODUCTION

Aspects of the present disclosure relate to extending network coordination for short-range networks, such as personal area networks, to remote devices.

A personal area network (PAN) is generally a type of computer network for interconnecting electronic devices over relatively shorter ranges, such as up to tens of meters, using wired and wireless connections. ZigBee® is one example of a PAN technology. The relatively shorter range of PANs enables low-power and cost-effective operation in various network topologies. However, this relatively shorter range can also complicate network design and function.

For example, a large site may require multiple PANs to provide sufficient network coverage across the site, and each PAN requires its own PAN coordinator (a device that is generally responsible for instantiating and maintaining devices on the PAN). The need for multiple PAN coordinators can complicate the implementation, maintenance, security, and performance of the site because the individual PANs cannot communicate with each other. Thus, for example, network authentication may need to be established over and over again as a wireless node roams between PANs at a single site. Moreover, the need for multiple PAN coordinators generally requires a complementary increase in deployed computing equipment (e.g., one processing system, such as computer or server, per PAN coordinator), which increases power use, points of failure, implementation complexity, and cost, to name a few challenges.

Accordingly, there is a need for improved methods of extending network coordination of short-range networks to remote devices.

### SUMMARY

A first embodiment provides a processing system for extending a personal area network, comprising: a memory comprising computer-executable instructions; a communication adapter; a processor configured to execute the computer-executable instructions and cause the processing system to: instantiate a plurality of network coordinators; instantiate a plurality of short-range networks (SRNs), each SRN of the plurality of SRNs being associated with a unique network coordinator of the plurality network coordinators; associate a remote device with a first SRN of the plurality of SRNs, wherein the remote device is not in wireless communication with the processing system; transmit data to the remote device via the communication adapter and the first SRN; and receive data from the remote device via the communication adapter and the first SRN.

Another embodiment provides a personal area network system, comprising: a first processing system, comprising: a memory comprising computer-executable instructions; a first communication adapter; a processor configured to execute the computer-executable instructions and cause the processing system to: instantiate a plurality of network coordinators; instantiate a plurality of short-range networks (SRNs), each SRN of the plurality of SRNs being associated with a unique network coordinator of the plurality network coordinators; associate a remote device with a first SRN of the plurality of SRNs, wherein the remote device is not in wireless communication with the processing system; transmit data to the remote device via the first communication adapter and the first SRN; and receive data from the remote device via the first communication adapter and the first SRN; and a second processing system, comprising: a second communication adapter; and a network coordinator device operatively coupled to the second communication adapter and configured to coordinate one of the PANs.

Another embodiment provides a method for extending a personal area network, comprising: instantiating a plurality of network coordinators; instantiating a plurality of short-range networks (SRNs), each SRN of the plurality of SRNs being associated with a unique network coordinator of the plurality network coordinators; associating a remote device with a first SRN of the plurality of SRNs; transmitting data to the remote device via a communication adapter and the first SRN; and receiving data from the remote device via the communication adapter and the first SRN.

Other aspects provide processing systems configured to perform the aforementioned methods as well as those described herein; non-transitory, computer-readable media comprising instructions that, when executed by a processors of a processing system, cause the processing system to perform the aforementioned methods as well as those described herein; a computer program product embodied on a computer readable storage medium comprising code for performing the aforementioned methods as well as those further described herein; and a processing system comprising means for performing the aforementioned methods as well as those further described herein.

The following description and the related drawings set forth in detail certain illustrative features of one or more embodiments.

### DESCRIPTION OF THE DRAWINGS

The embodiments set forth in the drawings are illustrative and exemplary in nature and not intended to limit the disclosure. The following detailed description of the illustrative embodiments can be understood when read in conjunction with the following drawings, where like structure is indicated with like reference numerals and in which:

FIG. 1 depicts an example computing environment in which network coordination for personal area networks may be extended.

FIG. 2 depicts an example software configuration for edge environment.

FIG. 3 depicts an example configuration for an edge environment.

FIGS. 4A-4C depict example hardware configurations for device that may be utilized in an edge environment, such as in the example of FIG. 3.

FIG. 5 depicts an example method for extending network coordination of short-range networks to remote devices.

FIG. 6 depicts an example processing system configured to perform the methods described herein.

### DETAILED DESCRIPTION

Embodiments disclosed herein include systems and methods for extending network coordination of short-range networks, such as personal area networks (PANs), to remote devices.

Generally, a network coordinator, such as a PAN coordinator, is the principal controller of an IEEE 802.15.4-based network that is responsible for network formation, including for associating and disassociating devices into its network. A ZigBee® coordinator is an example of a PAN coordinator.

Whereas conventional systems require a computing device collocated with each network coordinator, embodiments described herein overcome this technical limitation by extending a single computing device's data bus to one or more remote sites having their own network coordinators. In some embodiments, this extension is by way of universal serial bus (USB) over Ethernet, which allows a single computing device to manage the configurations of and data flows between multiple network coordinators over USB in locations remote from the single computing device, which conventionally would be well outside of the range of USB communications.

Beneficially, embodiments described herein enable the configuration and management of multiple network coordinators without the technical limitations and problems of conventional configurations. For example, maintenance, security configuration, authentication, and other aspects of a site-level network having multiple sub-networks (e.g., PANs) can be effectively accomplished using a single computing device in data communication with (e.g., over USB) each PAN. This decreases the amount of computing devices that need to be deployed at the site, which beneficially reduces power use, points of failure, implementation complexity, and cost, to name a few benefits.

Note that while PANs are described herein as one example of a type of network that may be improved through extended coordination, the concepts described herein may equally be applied to other types of networks having different characteristics (e.g., different wireless communication ranges).

### Example Computing Environment in which Coordination of Short-Range Networks May be Extended

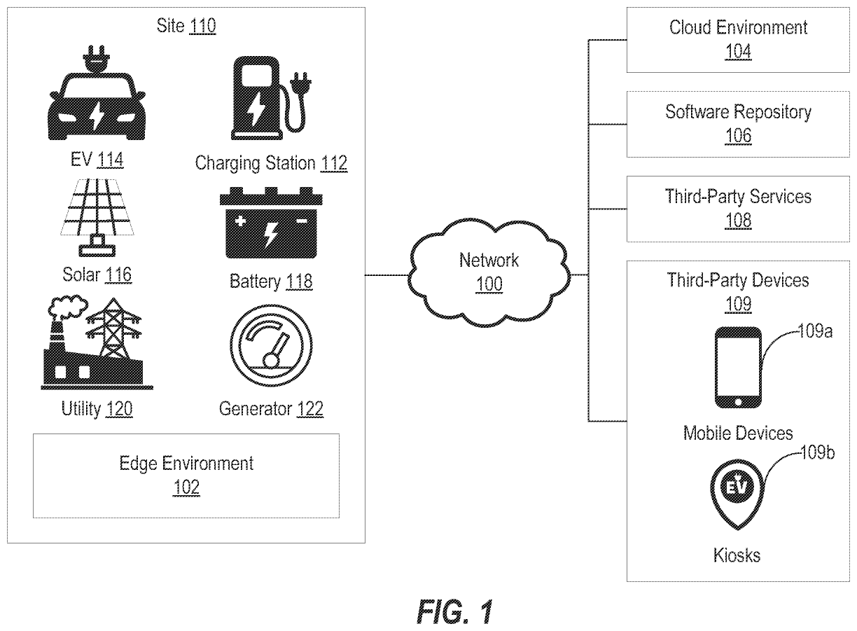

FIG. 1 depicts a computing environment in which coordination of short-range networks (e.g., PANs) may be extended.

As illustrated, the computing environment includes a network 100 that is coupled to an edge environment 102, a cloud environment 104, a software repository 106, as well as ancillary devices 108. The network 100 may be configured as any wide area network (WAN, such as the internet, power network, cellular network, etc.) or other network for facilitating communication among the edge environment 102, cloud environment 104, software repository 106, third-party services 108, and third-party devices 109, including in this example, mobile devices 109a and kiosks 109b. It should be noted that other devices and connections are possible, and those depicted are just some examples.

Edge environment 102 may generally be deployed at site 110 to provide various services, including coordination and optimization of charging of electric vehicles (e.g., EV 114) using charging station 112 and various distributed energy sources (DERs), such as solar installation 116, batter energy storage system (BESS) 118, utility grid connection 120, and generator 122 (e.g., an onsite diesel, natural gas, or other type of fueled generator). Generally, the aforementioned DERs may provide energy to the charging station 112 and/or use energy from the charging station 112 (e.g., by way of a backflow of energy from EV 114 to other aspects of site 110). For example, in some embodiments, charging station 112 may send excess energy back to the battery 118 and/or to utility 120. Generally, edge environment 102 may monitor and/or modify the energy sent to and received from the DERs to optimize various tasks, such as charging of EV 114.

Charging station 112 may utilize various communication protocols, such as open smart charging protocol (OSCP), open charge point interface (OCPI), ISO 15118, OpenADR, etc. and may represent Level 1, Level 2, Level 3, and higher level charging stations, as applicable. Generally, the “level” of a charging station refers to the power level and/or ability to provide electric power to a device being charged.

In some embodiments, edge environment 102 may implement a plurality of short-range wireless data networks, such as PANs, to provide network communication to the aforementioned aspects of site 110 (and others).

Edge environment 102 is configured as an interface between various aspects of site 110 and network 100. In various embodiments, compute resources for performing different functions at a site, such as optimization of EV charging, may be split between local compute resources in edge environment 102 and remote compute resources, e.g., in cloud environment 104 of FIG. 1.

Cloud environment 104 is coupled to the edge environment 102 via the network 100 and may be configured for further processing of data, as described herein. While FIG. 1 depicts a single cloud environment 104 that serves a single edge environment 102, this is merely an example, as some embodiments may be configured such that the cloud environment 104 may serve a plurality of edge environments 102 that each serve one or more sites 110, one or more charging stations 112, one or more DERs, and the like.

Software repository 106 is also coupled to site 110 via network 100. Software repository 106 may be configured as a platform to program, store, manage, control changes, etc. to software that is implemented in edge environment 102 and/or cloud environment 104. In some embodiments, software repository 106 may be configured as a proprietary service and/or may be provided by a third-party, such as GitHub™. Additionally, some embodiments may be configured such that the software repository 106 is provided by the same entity that manages the cloud environment 104. As such, these embodiments may be configured such that software repository 106 and cloud environment 104 may be combined.

Also depicted in FIG. 1 are third-party services 108 and third-party devices 109. An example of a third-party service is an operations management service that may be utilized to monitor and/or alter operations of site 110. Third-party devices 109 may include things such as mobile devices 109a and kiosks 109b, to name just a few examples.

Mobile device 109a may represent an administrator device and/or a user device. As a user device, mobile device 109a may initiate charging, payment, and/or perform other user-specific actions. As an administrator device, mobile device 109a may perform administrative operations, analysis, and/or perform other actions.

Kiosk 109b may provide user-specific or administrative actions, similar to that of the mobile device 109a. In some embodiments, administrators may use the kiosk 109b to view information about the site and/or to make changes to site configurations. Note that while kiosk 109b is depicted as being remote from site 110, in other embodiments, kiosk 109b may be collocated with site 110, such as collocated with charging station 112.

As will be understood, third-party devices 109 may each include a processor, a memory component, and/or other hardware and/or software for preforming the functionality provided herein.

### Example Aspects of Edge Environment

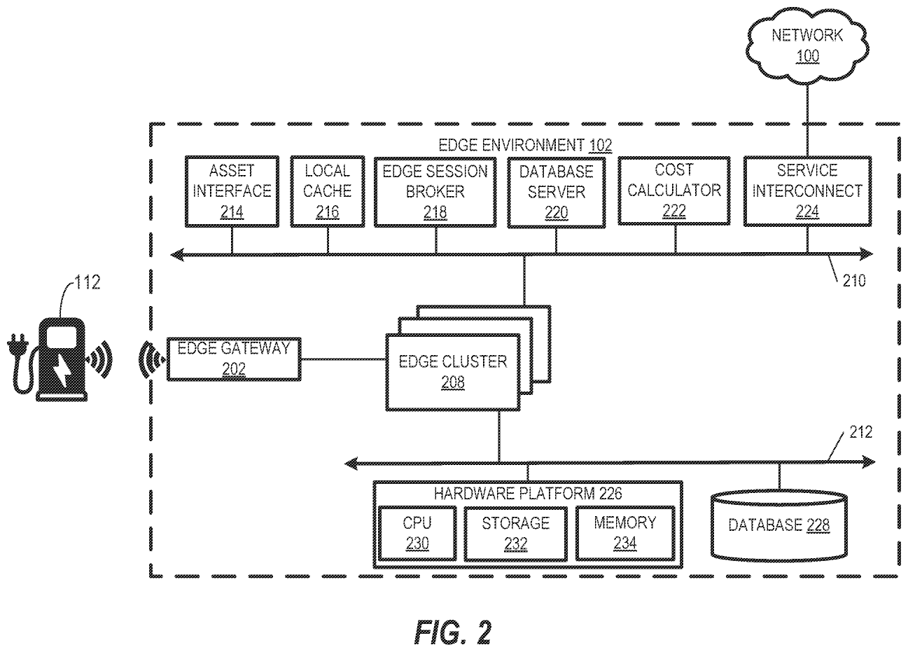

FIG. 2 depicts further details of an example edge environment 102.

Edge environment 102 may be operatively coupled to aspects of site 110, such as charging station 112 (depicted) via edge gateway 202.

Edge environment 102 further includes an edge cluster 208, which is coupled to communication bus 210 and hardware bus 212. Communication bus 210 is coupled to asset interface 214, local cache 216, edge session broker 218, database server 220, cost calculator 222, and service interconnect 224 in this example. Hardware bus 212 is further coupled to hardware platform 226, which may include one or more processors, such as CPU 230, storage component 232, memory component 234, and/or other hardware components. Also coupled to hardware bus 212 is database 228.

Bus 210 may be utilized to facilitate operation of all services that run in edge environment 102 and communicate with each other via a distributed message streaming system. The coupling of these aforementioned services 208-228 may be accomplished in one embodiment via a distributed message streaming system, such as NATS.

In the depicted example, charging station 112 is configured for communication with edge environment 102 via edge gateway 202 via a short-range wireless network technology, such as via a ZigBee® PAN. The edge gateway 202 may be configured to receive data, such as electric charging data, price charge data, vehicle data, etc. from the charging station 112 and/or vehicles that are being charged via the connection with the site 110 (of FIG. 1).

In some embodiments, edge gateway 202 may be configured to abstract data received from aspects of site 110 (of FIG. 1), such as charging station 112, to remove protocol-specific distinctions. For example, a first charging station may utilize a first communication protocol and/or billing protocol and a second charging station may utilize a second communication protocol and/or billing protocol. Edge gateway 202 may receive data packets from both the first charging station using the first communication protocol and the second charging station using the second communication protocol and may transform the received data into a protocol-agnostic format prior to providing the data to edge cluster 208. This allows wide interoperability between edge environment 102 and various types of hardware (e.g., charging station 112) at a site.

Edge cluster 208 is the central message center in various embodiments. For example, when a user plugs a vehicle into a charging station 112, edge cluster 208 receives data from edge gateway 202, parses that data (e.g., to generate access state data) and cause the state data to be sent to the database server 220. Edge cluster 208 also receives the data and creates a session entry, which may be stored in the local cache 216. Edge cluster 208 may additionally send the session entry to the cloud environment 104 (of FIG. 1) via network 100. Edge session broker 218 may also receive data related to the new session and may query database server 220 to access additional session data to determine charging characteristics for charging station 112.

Edge session broker 218 may be configured to produce data or signals that are sent to the edge cluster 208, which may then be sent to charging station 112 via edge gateway 202. The data or signals may indicate, for example, current delivered over time (e.g., amperes), total energy delivered (e.g., kWh), power delivered over time (e.g., kW), voltage at the charging station over time (e.g., V), charging station state (e.g., connected, disconnect, offline). Charging stations 112 may report any errors back to edge cluster 208 via edge gateway 202.

Cost calculator 222 is configured to access pricing data from cloud environment 104 (of FIG. 1) and may to costs incurred based on delivered energy, expected costs prior to charging, idle time interval, parking time interval, etc.

Asset interface 214 acts as an interface between edge environment 102 and various DERs, such as described above with respect to FIG. 1.

Edge cluster 208 may be configured such that any message received by the edge cluster 208 may also be sent to the cloud environment 104 (of FIG. 1) for consumption by a data subscriber in the cloud environment. For example, if a user of the mobile device 109a (in FIG. 1) desires to claim a charging session, mobile device 109b does not need to access edge environment 102 directly. Instead, mobile device 109b may connect with the cloud environment 104 (of FIG. 1), which sends a message to the edge cluster 208 with an instruction to claim the session.

Service interconnect 224 is configured for establishing an HTTP, TCP, and/or other type of communication with the cloud environment 104 (of FIG. 1) via network 100.

Hardware platform 226 represents any hardware for facilitating the processes and actions described herein. Specifically, CPU 230 may represent one or more types of processing device configured for executing instructions. Storage component 232 may be configured as long term storage, such as a hard drive or the like. Memory component 234 may include any of various types or read access memory or the like. Database 228 may be configured for additional storage and may be housed with the other hardware and/or elsewhere.

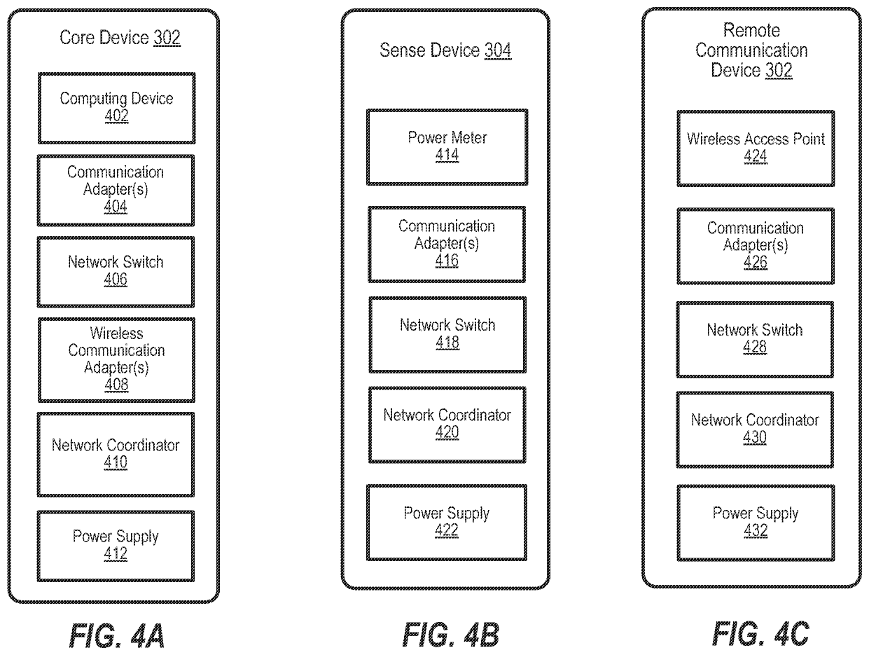

Examples of different hardware platforms that may be deployed in edge environment 102 are described further below with respect to FIGS. 4A-4C.

### Example Edge Environment Configuration for Extending Network Coordination of Short-Range Networks to Remote Devices

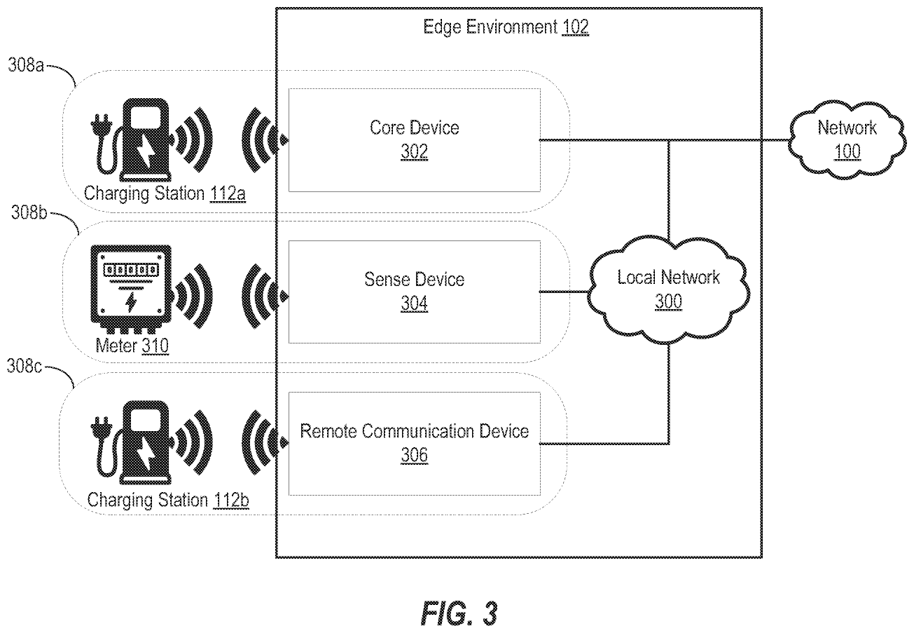

FIG. 3 depicts an example configuration for an edge environment 102 configured to extend network coordination of short-range networks to remote devices.

In this example, edge environment 102 is a distributed control and data acquisition architecture made up of three components, including a core device 302, sense device 304, and remote communications device 306. Together these component implement many important functions, including Internet of things (IOT) connectivity, asset power and energy metering, compute resources for asset optimization, cellular communications, and secure networking, which enables scalable and reliable integration of all energy generation and storage assets.

In a typical installation, core device 302 acts as a central “brain” of the edge environment 102 and serves as the communications hub for sense device 304 and remote communication device 306 via local network 300, which may be implemented by wired and/or wireless communications links.

Core device 302 communicates with wide area network 100 for accessing cloud services and data, such as for retrieving the latest optimization and load management set points for charging stations and battery storage assets) (e.g., from cloud environment 104 in FIG. 1). Core device 302 then dispatches these set points, either through a local connection or through a remote communication device (e.g., 306) to reach locations that are distant or hard to reach, such as sub-levels of a parking garage or a rooftop solar inverter. Core device 302 is further able to collect data directly from DERs, such as those described above with respect to FIG. 1. Power and energy metering data is collected via sense device 304, which may in various examples include a smart meter with support for multiple single- and three-phase loads with a local historian and network communication back to core device 302

Note that while one of each of core device 302, sense device 304, and remote communication device 306 are depicted, the system is scalable. For example, additional sense devices and remote communications devices 306 can be added to handle situations, such as a separate subpanel for energy metering of a new solar and/or BESS application or for monitoring of a new inverter associated with a rooftop solar installation.

As depicted in FIG. 3, communications between various edge environment 102 devices (e.g., core device 302, sense device 304, and remote communications device 306) and other site devices, like charging stations 112 and utility meter 310, may be performed by wireless communication technologies, such as a short-range wireless communication technology (e.g., a PAN technology) like ZigBee®. In particular, FIG. 3 depicts a PAN 308a enabling wireless communications between core device 302 and charging station 112a, another PAN 308b enabling wireless communications between sense device 304 and utility meter 310, and a final PAN 308c enabling wireless communications between remote communication device 306 and charging station 112b.

As above, this configuration would conventionally require a PAN coordinator and complementary computing equipment in each of core device 302, 304, and 306. And in the conventional configuration, the PAN coordinators would not be able to interact, leading to the various technical problems described above.

Beneficially, embodiments described herein overcome the technical problems of conventional configurations by enabling core device 302 to extend a data bus (e.g., a universal serial bus (USB) data connection) to remote devices, such as sense device 304 and/or remote communications device 306. When extended to these remote devices, core device 302 may control PAN coordinators (e.g., ZigBee® coordinators) collocated with the remote devices, and therefore share information among the remote PAN networks (e.g., 308b and 308c) implemented by the remote PAN coordinators, including configuration, security, and other settings and information.

In one example, core device 302 includes communication adapters that extend a universal serial bus (USB) data connection to sense device 304 and/or remote communication device 306 using Ethernet, which provides significantly more range than short-range data connections, such as USB. In some examples, core device 302 includes a USB hub in order to allow connection of additional USB devices at the remote device locations, such as USB-based PAN coordinator devices.

To manage multiple PAN coordinators simultaneously, core device 302 may include one or more software modules that manage communications to, from, and between each network coordinator as well as devices connected to the PANs controlled by each network coordinator. The modules may further manage mappings between devices and PANs so that communications may be routed efficiently from core device 302 to a particular PAN network serving a particular endpoint device, and vice versa.

Accordingly, embodiments described herein overcome technical shortcomings of conventional short-range network (e.g., PAN) deployments and enable new technical capabilities, such as using a single computing device (e.g., a computer, server, or the like) to manage multiple network coordinators in disparate locations simultaneously. This allows for extending network control of short-range networks beyond RF range of any one short-range network (e.g., outside of mesh range of a ZigBee® network). This further allows for collocating short-range networks in an area dense with connecting devices (e.g., more devices than can be handled by a single network coordinator).

### Example Hardware Devices for an Edge Environment

FIGS. 4A-4C depict example hardware devices that may be utilized in an edge environment, such as in the example of FIG. 3.

Specifically, FIG. 4A depicts hardware components that may be present in a core device 302. In some embodiments, the core device 302 is the brain where the energy optimization and adaptive load management functions are executed and dispatched. As illustrated, the core device 302 may include a computing device 402, a communication adapter 404 (or more than one), a network switch 406, a wireless communication adapter 408, a network coordinator 410 (e.g., a short-range network or PAN coordinator), and a power supply 412. As will be understood, the computing device may include a processor, memory, and/or other components that a normal, specific purpose machine may utilize. In some embodiments, the computing device 402 may include powerline communication (PLC) infrastructure, while some embodiments may utilize retail and/or micro-industrial computer components for optimization, load management, communication coordination, and/or historian services.

The communication adapter 404 may be configured to convert between various communication protocols and/or media, such as Modubus RTU (RS485) to Modbus TCP (Ethernet) or Ethernet IP (RJ45) to Ethernet Optical (SFP), etc. The network switch 406 may be configured for routing of network traffic, and may be configured as an Ethernet switch for communication to other nodes (e.g., the sense device 304, the remote communications device 306, and/or other core device 302), distributed energy resources, and/or energy based management systems.

The wireless communication adapter 408 may include a cellular modem, internet modem, Wi-Fi access point, etc. for facilitating wireless communications to the internet or other wide area network. Similarly, the network coordinator 410 may be configured to create and/or join communication connections with other devices. This may include a ZigBee® coordinator, Bluetooth device, and/or other device for performing this function. The power supply 412 may be configured as a battery power, connection to external power, etc.

It should be understood that in some embodiments, the computing device 402 may be embodied as the depiction of the edge environment 102 from FIG. 2. Specifically, the core device 302 may be configured as the central computing device of the edge environment and thus may provide the processing and workflow described with reference to FIG. 2. Some embodiments are not so limited.

FIG. 4B depicts hardware components of the sense device 304 from FIG. 3. The sense device may be configured as a smart-metering piece for collection and storage of power/energy data including but not limited to measurements such as temperature, voltage, current, power, solar irradiance, wind speed, etc. The sense device 304 may include a smart meter with multiple channels of measurement that may comprise single-phase circuits and/or three-phase circuits. The sense device 304 may communicate meter data back to the core device 302 from meter locations such as electrical rooms, rooftop solar installations, EV chargers, and subpanels. These embodiments may be optimized for ease of installation and reduced intrusion to the site. Power over Ethernet (POE) sourced from the core device 302 suffices for most installations. The sense device 304 may transmit data back to the core device 302 via a network switch. The sense device is optimized to utilize minimal power and PoE is acceptable for most installations.

As illustrated in FIG. 4B, the sense device 304 includes a power meter 414, a communication adapter 416, a network switch 418, and may include a network coordinator 420, and a power supply 422. The power supply 422 may include a power interface for providing power to the sense device 304. The power meter 414 may be utilized for monitoring single-phase and three-phase loads of power. The communication adapter 416 may be utilized for facilitating communications between the sense device 304 and other devices. The network switch 418 may be a PoE enabled switch for communication. Similarly, the network coordinator 420 may create personal area networks, such as via ZigBee®, Bluetooth, and the like.

As illustrated in FIG. 4C, the remote communications device 306 is a network-connectivity extension, primarily for EV charging or solar monitoring locations where ZigBee®, Wi-Fi, or Ethernet is being extended to remote or difficult-to-reach locations such as remote subpanels, parking garage levels, or rooftop inverters. Some embodiments are optimized for ease of installation and reduced intrusion to the site where PoE suffices for most installations from the core device 302. The remote communications device 306 may be configured to transmit data back to the core device 302 via the network switch.

Specifically, the remote communications device 306 may include a wireless access point 424, a communication adapter 426, a network switch 428, and may include a network coordinator 430, and a power supply 432. The wireless access point 424 may be configured to extend wireless communication signals to chargers and/or other intelligent electronic devices. The communication adapter 426 may be configured for facilitating communications between the remote communications device 306 and other devices. The network switch 428 may be configured as a PoE Ethernet switch and/or other network switch for communicating with the core device 302. The network coordinator 430 may be configured to create personal area networks, such as via ZigBee®, Bluetooth, and the like. The power supply 432 may include a power interface for providing power to the sense device 304.

### Example Method of Extending Network Coordination of Short-Range Networks to Remote Devices

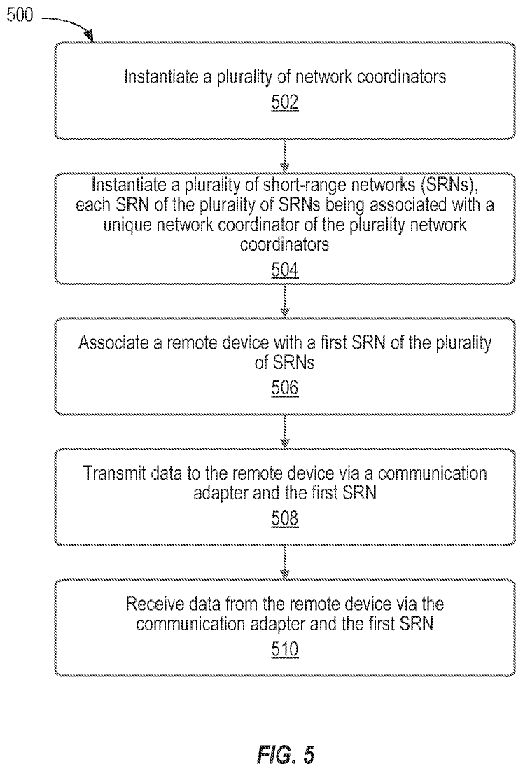

FIG. 5 depicts an example method 500 for extending network coordination of short-range networks to remote devices. For example, as described with respect to FIG. 3, network coordination for PANs 308a-308c may be managed by a single computing device in core device 302.

Method 500 begins at step 502 with instantiating a plurality of network coordinators (e.g., short-range network coordinators, such as PAN coordinators).

In some embodiments, the plurality of network coordinators are instantiated by mounting the devices via universal serial bus (USB). In some embodiments, at least one network coordinator of the plurality of network coordinators is mounted to the processing system via universal serial bus (USB). In some embodiments, at least one network coordinator of the plurality of network coordinators is implemented as a software module within the memory.

Method 500 then proceeds to step 504 with instantiating a plurality of short-range networks (SRNs), each SRN of the plurality of SRNs being associated with a unique network coordinator of the plurality network coordinators.

Method 500 then proceeds to step 506 with associating a remote device with a first SRN of the plurality of SRNs. In some embodiments, the first PAN comprises a ZigBee® network.

Method 500 then proceeds to step 508 with transmitting data to the remote device via a communication adapter and the first SRN. In some embodiments, the data transmitted to the remote device comprises control instructions for a charging station (e.g., an electric vehicle station equipment). In some embodiments, the remote device is a charging station or battery energy storage system, and the data is, for example, optimization and load management set points.

Method 500 then proceeds to step 510 with receiving data from the remote device via the communication adapter and the first SRN.

In some embodiments, method 500 further includes determining, for a data packet, which SRN of the plurality of SRNs with which to transmit the data packet. For example, with reference to FIG. 3, the method may include determining which of the wireless networks 308a-308c is connected to the device intended to receive the data packet.

In some embodiments, method 500 further includes maintaining a database identifying relationships between a plurality of remote devices and the plurality of SRNs.

In some embodiments, the communication adapter is configured to extend a universal serial bus (USB) over Ethernet, such as described above with reference to FIG. 3.

In some embodiments, a core device, such as core device 302 described above with reference to FIG. 3, performs method 500.

Note that method 500 is just one example of a method consistent with the embodiments described herein, and other methods are possible that omit, add, or substitute steps consistent with this disclosure.

### Example Processing System for Extending Network Coordination of Short-Range Networks to Remote Devices

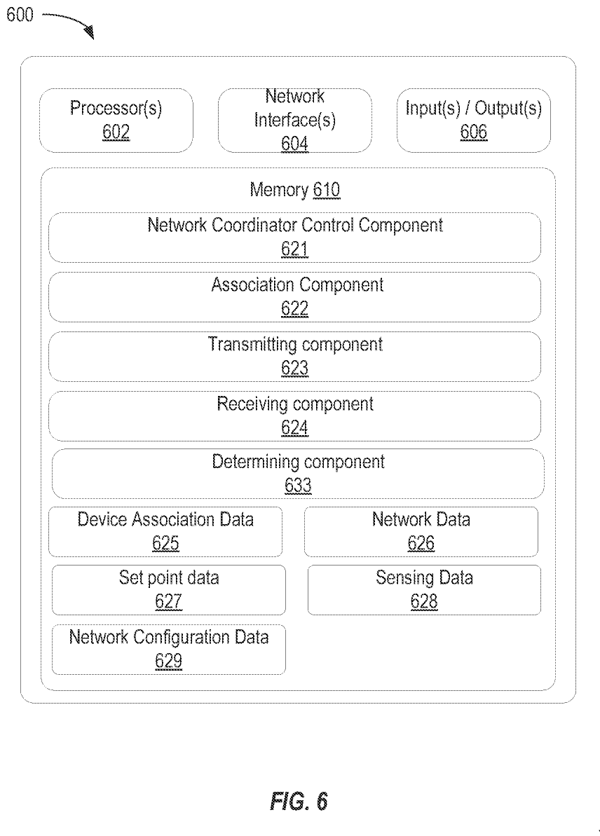

FIG. 6 depicts an example processing system 600 configured to perform the methods described herein.

Processing system 600 includes one or more processors 602. Generally, a processor 602 is configured to execute computer-executable instructions (e.g., software code) to perform various functions, as described herein.

Processing system 600 further includes a network interface 604, which generally provides data access to any sort of data network, including personal area networks (PANs), local area networks (LANs), wide area networks (WANs), the Internet, and the like.

Processing system 600 further includes input(s) and output(s) 606, which generally provide means for providing data to and from processing system 600, such as via connection to computing device peripherals, including user interface peripherals.

Processing system 600 further includes a memory 610 comprising various components. In this example, memory 610 includes a network coordinator control component 621, an association component 622, a transmitting component 623, a receiving component 624, a determining component 633, device association data 625, network data 626, set point data 627, sensing data 628, and network configuration data 629.

Processing system 600 may be implemented in various ways. For example, processing system 600 may be implemented as a computing device 402 within core device 302, described above with respect to FIGS. 3 and 4. Note that in various implementations, aspects may be omitted, added, or substituted from processing system 600.

### Example Clauses

Implementation examples are described in the following numbered clauses:

Clause 1: A processing system for extending a personal area network, comprising: a memory comprising computer-executable instructions; a communication adapter; a processor configured to execute the computer-executable instructions and cause the processing system to: instantiate a plurality of network coordinators; instantiate a plurality of short-range networks (SRNs), each SRN of the plurality of SRNs being associated with a unique network coordinator of the plurality network coordinators; associate a remote device with a first SRN of the plurality of SRNs, wherein the remote device is not in wireless communication with the processing system; transmit data to the remote device via the communication adapter and the first SRN; and receive data from the remote device via the communication adapter and the first SRN.

Clause 2: The processing system of Clause 1, wherein the processor is further configured to cause the processing system to determine, for a data packet, which SRN of the plurality of SRNs with which to transmit the data packet.

Clause 3: The processing system of any one of Clauses 1-2, wherein the processor is further configured to cause the processing system to maintain a database identifying relationships between a plurality of remote devices and the plurality of SRNs.

Clause 4: The processing system of any one of Clauses 1-3, wherein the first SRN comprises a ZigBee® network.

Clause 5: The processing system of any one of Clauses 1-4, wherein the communication adapter is configured to extend a universal serial bus (USB) over Ethernet.

Clause 6: The processing system of any one of Clauses 1-5, wherein the plurality of network coordinators are mounted to the processing system via universal serial bus (USB).

Clause 7: The processing system of any one of Clauses 1-6, wherein at least one network coordinator of the plurality of network coordinators is mounted to the processing system via universal serial bus (USB).

Clause 8: The processing system of any one of Clauses 1-7, wherein at least one network coordinator of the plurality of network coordinators is implemented as a software module within the memory.

Clause 9: The processing system of any one of Clauses 1-8, wherein the data transmitted to the remote device comprises control instructions for a charging station.

Clause 10: The processing system of any one of Clauses 1-9, wherein the data received from the remote device comprises status information for a charging station.

Clause 11: A personal area network system, comprising: a first processing system, comprising: a memory comprising computer-executable instructions; a first communication adapter; a processor configured to execute the computer-executable instructions and cause the processing system to: instantiate a plurality of network coordinators; instantiate a plurality of short-range networks (SRNs), each SRN of the plurality of SRNs being associated with a unique network coordinator of the plurality network coordinators; associate a remote device with a first SRN of the plurality of SRNs, wherein the remote device is not in wireless communication with the processing system; transmit data to the remote device via the first communication adapter and the first SRN; and receive data from the remote device via the first communication adapter and the first SRN; and a second processing system, comprising: a second communication adapter; and a network coordinator device operatively coupled to the second communication adapter and configured to coordinate one of the SRNs.

Clause 12: The personal area network system of Clause 11, wherein the network coordinator device comprises a USB ZigBee® device.

Clause 13: A method for extending a personal area network, comprising: instantiating a plurality of network coordinators; instantiating a plurality of short-range networks (SRNs), each SRN of the plurality of SRNs being associated with a unique network coordinator of the plurality network coordinators; associating a remote device with a first SRN of the plurality of SRNs; transmitting data to the remote device via a communication adapter and the first SRN; and receiving data from the remote device via the communication adapter and the first SRN.

Clause 14: The method of Clause 13, further comprising determining, for a data packet, which SRN of the plurality of SRNs with which to transmit the data packet.

Clause 15: The method of any one of Clauses 13-14, further comprising maintaining a database identifying relationships between a plurality of remote devices and the plurality of SRNs.

Clause 16: The method of any one of Clauses 13-15, wherein the first SRN comprises a ZigBee® network.

Clause 17: The method of any one of Clauses 13-16, wherein the communication adapter is configured to extend a universal serial bus (USB) over Ethernet.

Clause 18: The method of any one of Clauses 13-17, wherein the plurality of network coordinators are mounted to the processing system via universal serial bus (USB).

Clause 19: The method of any one of Clauses 13-18, wherein at least one network coordinator of the plurality of network coordinators is mounted to the processing system via universal serial bus (USB).

Clause 20: The method of any one of Clauses 13-19, wherein at least one network coordinator of the plurality of network coordinators is implemented as a software module within the memory.

Clause 21: The method of any one of Clauses 13-20, wherein the data transmitted to the remote device comprises control instructions for a charging station.

Clause 22: A processing system, comprising: a memory comprising computer-executable instructions; and a processor configured to execute the computer-executable instructions and cause the processing system to perform a method in accordance with any one of Clauses 13-21.

Clause 23: A processing system, comprising means for performing a method in accordance with any one of Clauses 13-21.

Clause 24: A non-transitory computer-readable medium comprising computer-executable instructions that, when executed by a processor of a processing system, cause the processing system to perform a method in accordance with any one of Clauses 13-21.

Clause 25: A computer program product embodied on a computer-readable storage medium comprising code for performing a method in accordance with any one of Clauses 13-21.

### Additional Considerations

The preceding description is provided to enable any person skilled in the art to practice the various embodiments described herein. The examples discussed herein are not limiting of the scope, applicability, or embodiments set forth in the claims. Various modifications to these embodiments will be readily apparent to those skilled in the art, and the generic principles defined herein may be applied to other embodiments. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, the word “exemplary” means “serving as an example, instance, or illustration.” Any aspect described herein as “exemplary” is not necessarily to be construed as preferred or advantageous over other aspects.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the embodiments shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A processing system for extending a personal area network, comprising:
a memory comprising computer-executable instructions;
a communication adapter;
a processor configured to execute the computer-executable instructions and cause the processing system to:
instantiate a plurality of network coordinators;
instantiate a plurality of short-range networks (SRNs), each SRN of the plurality of SRNs being associated with a unique network coordinator of the plurality network coordinators;
associate a remote device with a first SRN of the plurality of SRNs, wherein the remote device is not in wireless communication with the processing system;
transmit data to the remote device via the communication adapter and the first SRN; and
receive data from the remote device via the communication adapter and the first SRN.

2. The processing system of claim 1, wherein the processor is further configured to cause the processing system to determine, for a data packet, which SRN of the plurality of SRNs with which to transmit the data packet.

3. The processing system of claim 1, wherein the processor is further configured to cause the processing system to maintain a database identifying relationships between a plurality of remote devices and the plurality of SRNs.

4. The processing system of claim 1, wherein the first SRN comprises a ZigBee® network.

5. The processing system of claim 1, wherein the communication adapter is configured to extend a universal serial bus (USB) over Ethernet.

6. The processing system of claim 1, wherein the plurality of network coordinators are mounted to the processing system via universal serial bus (USB).

7. The processing system of claim 1, wherein at least one network coordinator of the plurality of network coordinators is mounted to the processing system via universal serial bus (USB).

8. The processing system of claim 1, wherein at least one network coordinator of the plurality of network coordinators is implemented as a software module within the memory.

9. The processing system of claim 1, wherein the data transmitted to the remote device comprises control instructions for a charging station.

10. The processing system of claim 1, wherein the data received from the remote device comprises status information for a charging station.

11. A personal area network system, comprising:
a first processing system, comprising:
a memory comprising computer-executable instructions;
a first communication adapter;
a processor configured to execute the computer-executable instructions and cause the processing system to:
instantiate a plurality of network coordinators;
instantiate a plurality of short-range networks (SRNs), each SRN of the plurality of SRNs being associated with a unique network coordinator of the plurality network coordinators;
associate a remote device with a first SRN of the plurality of SRNs, wherein the remote device is not in wireless communication with the processing system;
transmit data to the remote device via the first communication adapter and the first SRN; and
receive data from the remote device via the first communication adapter and the first SRN; and
a second processing system, comprising:
a second communication adapter; and
a network coordinator device operatively coupled to the second communication adapter and configured to coordinate one of the SRNs.

12. The personal area network system of claim 11, wherein the network coordinator device comprises a USB ZigBee® device.

13. A method for extending a personal area network, comprising:
instantiating a plurality of network coordinators;
instantiating a plurality of short-range networks (SRNs), each SRN of the plurality of SRNs being associated with a unique network coordinator of the plurality network coordinators;
associating a remote device with a first SRN of the plurality of SRNs;
transmitting data to the remote device via a communication adapter and the first SRN; and
receiving data from the remote device via the communication adapter and the first SRN.

14. The method of claim 13, further comprising determining, for a data packet, which SRN of the plurality of SRNs with which to transmit the data packet.

15. The method of claim 13, further comprising maintaining a database identifying relationships between a plurality of remote devices and the plurality of SRNs.

16. The method of claim 13, wherein the first SRN comprises a ZigBee® network.

17. The method of claim 13, wherein the communication adapter is configured to extend a universal serial bus (USB) over Ethernet.

18. The method of claim 13, wherein the plurality of network coordinators are mounted to the processing system via universal serial bus (USB).

19. The method of claim 13, wherein at least one network coordinator of the plurality of network coordinators is mounted to the processing system via universal serial bus (USB).

20. The method of claim 13, wherein at least one network coordinator of the plurality of network coordinators is implemented as a software module within the memory.
